(19) United States
(12) Patent Application Publication
(10) Pub. No.: US 2007/0288905 A1
(43) Pub. Date: Dec. 13, 2007

(54) SYNC POINT INDICATING TRACE STREAM STATUS

(75) Inventors: Manisha AGARWALA, Richardson, TX (US); John M. Johnsen, Richardson, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/383,668

(22) Filed: May 16, 2006

(51) Int. Cl. G06F 9/44

(52) U.S. Cl. 717/128

(57) ABSTRACT

A system comprising a processor adapted to execute software code and a trace logic coupled to the processor and adapted to collect trace information associated with the processor while the software code is executed. The trace information is partitioned into multiple trace streams. The trace logic inserts one or more status bits into a trace stream, the one or more status bits indicative of a current status of one or more of the trace streams and not indicative of a previous status of the one or more of the trace streams.

### BACKGROUND

A software developer may use debugging software running on a host computer to test and debug an application stored on hardware coupled to the host computer. While the application is being tested and debugged, various information is transferred from the hardware to the host computer. Improvements that increase the efficiency of such information transfers are desirable.

### SUMMARY

The problems noted above are solved in large part by sync points that indicate the current status of one or more trace streams. An illustrative embodiment includes a system comprising a processor adapted to execute software code and a trace logic coupled to the processor and adapted to collect trace information associated with the processor while the software code is executed. The trace information is partitioned into multiple trace streams. The trace logic inserts one or more status bits into a trace stream, the one or more status bits indicative of a current status of one or more of the trace streams and not indicative of a previous status of the one or more of the trace streams.

Another illustrative embodiment includes information carrier medium containing software that, when executed by a processor, causes the processor to receive a first stream of trace information from a target hardware coupled to the processor, the first stream comprising a status bit, the trace information indicative of activity of another processor on the target hardware. The software also causes the processor to determine a status of the first stream using the status bit. The status bit is indicative of a current status of the first stream and not indicative of a previous status of the first stream.

Yet another illustrative embodiment includes method that comprises receiving a first stream of trace information from a target hardware, the first stream comprising a status bit and indicative of activity of a processor on the target hardware. The method also comprises determining a status of the first stream using the status bit. The status bit is indicative of a current status of the first stream and not indicative of a previous status of the first stream.

### BRIEF DESCRIPTION OF THE DRAWINGS

For a detailed description of exemplary embodiments of the invention, reference will now be made to the accompanying drawings in which:

FIG. 1 shows a block diagram of a testing system in accordance with embodiments of the invention;

FIG. 2 shows a plurality of trace streams in accordance with embodiments of the invention; and

FIG. 3 shows a sync point in accordance with preferred embodiments of the invention.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

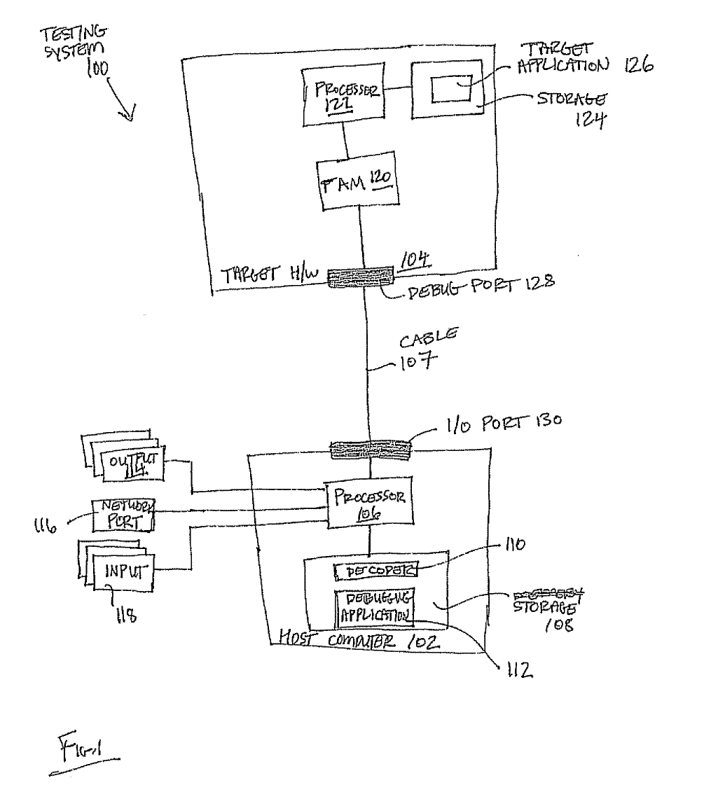

FIG. 1 shows an illustrative testing system 100 in accordance with embodiments of the invention. The testing system 100 comprises a general purpose host computer 102 and target hardware 104 coupled via a cable 107. The cable 107 couples the input/output (I/O) port 130 of the host computer 102 with the debug port 128 of the target hardware 104. In at least some embodiments, the debug port 128 may include a Joint Test Action Group (JTAG) port, although the scope of disclosure is not limited as such. In some embodiments, the target hardware 104 may be, or may be incorporated into, a mobile communication device such as a mobile phone, a personal digital assistant (e.g., a BLACKBERRY® device), or other type of electronic system. The target hardware 104 and the host computer 102 are now described in turn.

In some embodiments, the target hardware 104 comprises a megacell or a system-on-chip (SoC) which includes a control logic such as a processor 122 (e.g., digital signal processor (DSP)) and a storage 124 (e.g., random access memory (RAM)). The storage 124 stores one or more target applications 126 (e.g., embedded applications) which, when executed by the processor 122, perform any suitable function associated with the target hardware 104. As described further below, the host computer 102 is used to test and/or debug the one or more target applications 126. The remainder of this discussion assumes that a single target application 126 is being tested/debugged, although in some embodiments, multiple applications may be tested and debugged using the techniques described herein.

While the target application 126 is being debugged by the host computer 102, various information is transferred from the processor 122 to the host computer 102. Such information may include trace information. Trace information describes the various activities of the processor 122 as the processor 122 executes the target application 126. The trace information is provided so that a user of the host computer 102 can “step through” the software code of the target application 126 and determine how the processor 122 reacts to each line of code that is executed. Accordingly, the target hardware 104 also includes a trace acquisition module (TAM) 120. The TAM 120 collects trace information output by the processor 122, processes the trace information, and transfers the trace information to the host computer 102 via the cable 107. The host computer 102 is now described.

The host computer 102 comprises a processor 106 coupled to the I/O port 130. The processor 106 also couples to a storage medium 108, one or more output devices 114, one or more input devices 118, and a network port 116. The storage medium 108 may comprise volatile memory (e.g., RAM), non-volatile storage such as ROM, a hard disk, a CD-ROM, a flash drive, a floppy disk, a compact disc, and/or combinations thereof. The storage 108 stores a debugging application 112 and a decoder 110. The decoder 110 comprises a software decoder, although in some embodiments, a hardware decoder coupled to the processor 106 may be used instead. The input devices 118 may include any one or more of a keyboard, mouse, audio input device, touchpad, etc. The output devices 114 may include any one or more of a display, a printer, a storage device (e.g., a hard drive, flash drive), etc. The processor 106 may use the network port 116 to exchange information with another electronic device communicably coupled to the network port 116, such as another computer on an Internet or intranet network connection. For example, the network port 116 may be used to download the debugging application 112 onto the host computer 102.

The debugging application 112 is executed on the processor 106 and is used to test and/or debug the target application 126 on the target hardware 104. More specifically, when the processor 106 executes the debugging application 112, the processor 106 sends signals to and receives signals from the target hardware 104 via the cable 107 and the ports 130 and 128. Signals transferred from the host computer 102 to the target hardware 104 generally comprise test and debug signals, and signals transferred from the target hardware 104 to the computer 102 generally comprise response signals, including trace information. In this way, the target application 126 embedded on the target hardware 104 is tested and debugged using the application 112.

Trace information output by the processor 122 and/or TAM 120 of the target hardware 104 preferably is partitioned into three separate streams of information: a timing stream, a program counter (PC) stream and a data stream. The timing stream contains various timing information associated with the processor 122 as the processor 122 executes the target application 126, such as whether the processor 122 is active or stalled for each processor clock cycle, etc. The PC stream includes various program counter information associated with the processor 122 as the processor 122 executes the target application 126, such as how the program counter is affected by exceptions, branches, etc. The data stream includes various data information associated with the processor 122 as the processor 122 executes the target application 126, such as data values that are accessed by the processor 122, etc. In some embodiments, fewer or more information streams may be used.

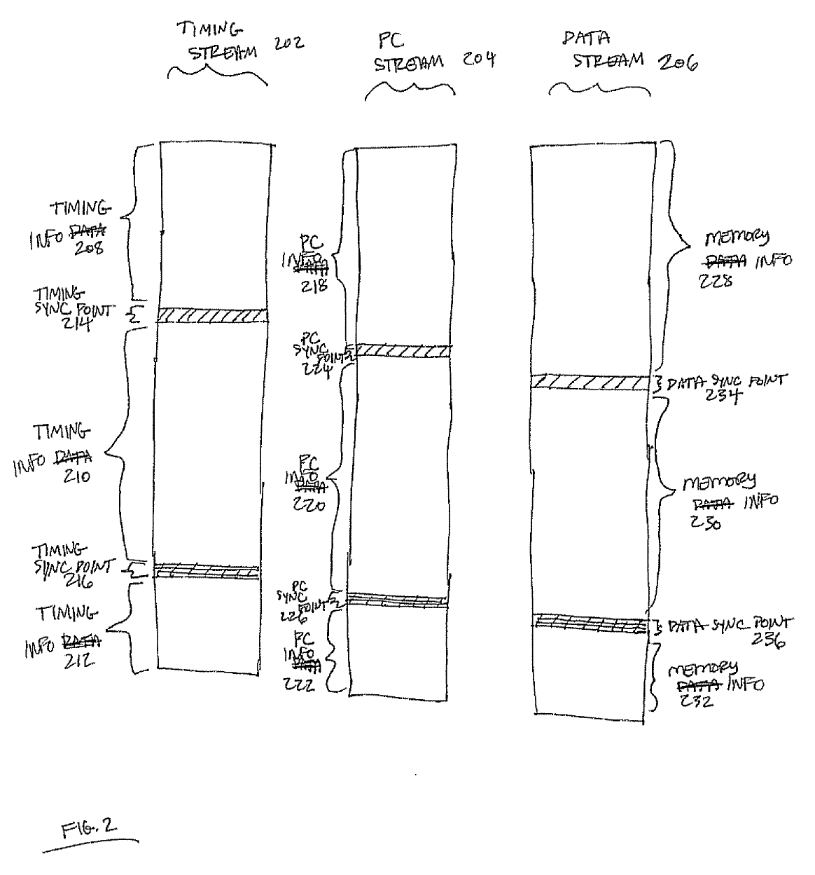

Each information stream includes one or more markers called “synchronization points,” or “sync points.” In some embodiments, a sync point comprises a packet of information generated by the target hardware 104 and destined for the host computer 102. At least some sync points across the three streams may include a common identifier which is used to synchronize the streams. For example, FIG. 2 shows a timing stream 202, a PC stream 204 and a data stream 206. The timing stream 202 comprises timing data 208 and 210 separated by a timing sync point 214. The timing stream 202 also comprises timing data 212 which is separated from timing data 210 by timing sync point 216. Likewise, the PC stream 204 comprises PC data 218 and 220 separated by PC sync point 224. The PC stream 204 also comprises PC data 222 separated from PC data 220 by PC sync point 226. Similarly, the data stream 206 comprises memory data 228 and 230 separated by data sync point 234. The data stream 206 also comprises memory data 232 separated from memory data 230 by data sync point 236.

In the example provided in FIG. 2, each of the sync points 214, 224 and 234 preferably comprises a common identifier (e.g., one or more common bits). The three streams preferably are synchronized by way of the identifiers. If, for any reason, the three streams become unsynchronized, the sync points 214, 224 and 234 are used to re-synchronize the three streams. For instance, assume the three streams are unsynchronized, and the three streams are provided to the TAM 120. The TAM 120 receives the timing sync point 214 first and determines that the timing sync point 214 has an identifier of “1.” The TAM 120 then stops the flow of the stream 202 and monitors the PC stream 204 for a sync point that has an identifier of “1.” Accordingly, the TAM 120 determines that the PC sync point 224 has an identifier of “1.” As such, the TAM 120 also stops the PC stream 204 and monitors the data stream 206 until a sync point having an identifier of “1” is located. When the TAM 120 determines that the data sync point 234 has an identifier of “1,” the TAM 120 re-activates the timing and PC streams, thereby synchronizing the three streams with each other. The timing sync point 216, PC sync point 226 and data sync point 236 may be used in a similar manner. Such is an example of one way in which the three streams may be synchronized with each other. The scope of disclosure is not limited to this synchronization technique.

Sync points are useful in various situations, one of which is when a software developer (i.e., user of the debugging application 112) desires to test and/or debug a specific portion of the target application 126. For example, if the developer desires to debug a specific portion of the target application 126, starting sync points (e.g., sync points 214, 224, 234) may be inserted such that the streams are synchronized before information associated with the specific portion of the application 126 appears in the streams. The starting sync points and ending sync points generally are used to indicate a starting point and an ending point of streams containing information that the user of the debugging application 112 desires to trace.

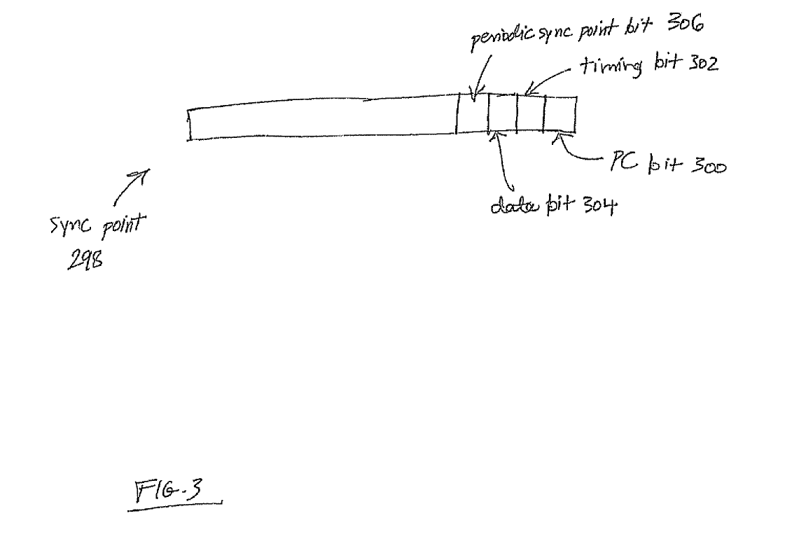

Various types of sync points are within the scope of disclosure. Starting sync points (e.g., PC sync point 224) may be used when a trace stream is being activated. An ending sync point (e.g., PC sync point 226) may be used when a trace stream is being deactivated. Sync points found between starting and ending sync points are periodic sync points that provide various additional trace information to the host computer 102. In accordance with embodiments of the invention, the sync points shown in FIG. 2 contain one or more bits which indicate the current status of one or more of the trace streams. In some embodiments, “current status” refers to the status of one or more trace streams after the issuance of the sync point. For example, as shown in FIG. 3, a sync point 298 (e.g., a PC sync point) may comprise a PC bit 300 that indicates the current status of the PC stream 204. In some embodiments, an active PC stream 204 corresponds to a PC bit 300 of “1” and an inactive PC stream 204 corresponds to a PC bit 300 of “0.” Alternatively, in other embodiments, an active PC stream 204 corresponds to a PC bit 300 of “0” and an inactive PC stream 204 corresponds to a PC bit 300 of “1.” When a stream is active, information is actively transmitted through the stream from the target hardware 104 to the host computer 102. When a stream is inactive, little or no information is actively transmitted through the stream from the target hardware 104 to the host computer 102 (e.g., the PC stream would transfer PC sync points but not PC information).

If an active PC stream is to switch to an inactive stream after the sync point 298 is issued, the PC bit preferably indicates an “inactive” status. Likewise, if an inactive PC stream is to switch to an active stream after the sync point 298 is issued, the PC bit preferably indicates an “active” status. A similar principle may apply to timing and data bits, which are described below.

Further, as shown in FIG. 3, the sync point 298 may comprise a timing bit 302 that indicates the current status of the timing stream 202. The timing bit 302 may be assigned a “1” bit or a “0” bit, as desired, to indicate whether the timing stream 202 is active or inactive. In some embodiments, the sync point 298 may comprise a data bit 304 that indicates the current status of the data stream 206. The data bit 304 may be assigned either a “1” bit or a “0” bit, as desired, to indicate whether the data stream 206 is active or inactive. Sync points that are in accordance with embodiments of the invention preferably do not comprise bits which indicate a previous active/inactive status of any of the trace streams. In some embodiments, the sync point 298 may further comprise a periodic sync point bit 306. The status of the bit 306 indicates whether the sync point is a periodic sync point or a non-periodic sync point. In some embodiments, a bit 306 comprising a “1” indicates that the sync point 298 is a periodic sync point, and a “0” indicates that the sync point is a non-periodic sync point. In other embodiments, a bit 306 comprising a “0” indicates that the sync point 298 is a periodic sync point, and a “1” indicates that the sync point is a non-periodic sync point.

When a sync point 298 is transferred to the host computer 102, the decoder 110 decodes the sync point 298 and determines the status of one or more of the bits 300, 302 and/or 304 to determine the current status of one or more of the trace streams. Because the sync point preferably does not contain information regarding previous statuses of any of the trace streams, information transfer between the target hardware 104 and the host computer 102, as well as the operation of the decoder 110, is made more efficient. The decoder 110 may additionally determine the status of the bit 306 to determine whether the sync point comprises a periodic sync point or a non-periodic sync point, thereby providing context information associated with the sync point. The techniques described herein also facilitate a simpler decoder design, since additional software code is not needed to process extraneous information in each sync point received.

The scope of disclosure is not limited to the views described above. Numerous variations and modifications will become apparent to those skilled in the art once the above disclosure is fully appreciated. It is intended that the following claims be interpreted to embrace all such variations and modifications.

What is claimed is:

1. A system, comprising:
a processor adapted to execute software code; and
a trace logic coupled to the processor and adapted to collect trace information associated with the processor while the software code is executed, said trace information partitioned into multiple trace streams;
wherein the trace logic inserts one or more status bits into a trace stream, said one or more status bits indicative of a current status of one or more of the trace streams and not indicative of a previous status of said one or more of the trace streams.

2. The system of claim 1, wherein the trace streams are selected from the group consisting of:
a timing stream that indicates a status of the processor for multiple clock cycles of the processor;
a program counter (PC) stream that indicates program counter information associated with the processor; and
a data stream that indicates data accessed by the processor.

3. The system of claim 1, wherein said one or more of the trace streams comprises a sync point which contains the one or more status bits, and wherein said sync point further comprises another bit which indicates that the sync point is a periodic sync point.

4. An information carrier medium containing software that, when executed by a processor, causes the processor to:
receive a first stream of trace information from a target hardware coupled to the processor, said first stream comprising a status bit, said trace information indicative of activity of another processor on the target hardware; and
determine a status of the first stream using said status bit;
wherein the status bit is indicative of a current status of the first stream and not indicative of a previous status of the first stream.

5. The information carrier medium of claim 4, wherein the software causes the processor to receive multiple streams of trace information, and wherein said first stream comprises multiple status bits, the status bits indicative of current statuses of the multiple streams and not indicative of previous statuses of the multiple streams.

6. The information carrier medium of claim 5, wherein said multiple streams include a timing stream that indicates a status of the another processor for multiple clock cycles of the another processor.

7. The information carrier medium of claim 5, wherein said multiple streams include a data stream that indicates data accessed by said another processor.

8. The information carrier medium of claim 4, wherein the first stream comprises a program counter (PC) stream which includes program counter information associated with said another processor.

9. The information carrier medium of claim 4, wherein the first stream comprises a sync point which contains the status bit, said sync point further comprising another bit which indicates that the sync point is a periodic sync point.

10. A method, comprising:
receiving a first stream of trace information from a target hardware, said first stream comprising a status bit and indicative of activity of a processor on the target hardware; and
determining a status of the first stream using said status bit;
wherein the status bit is indicative of a current status of the first stream and not indicative of a previous status of the first stream.

11. The method of claim 10, further comprising receiving multiple streams of trace information, wherein said first stream comprises multiple status bits, the status bits indicative of current statuses of the multiple streams and not indicative of previous statuses of the multiple streams.

12. The method of claim 11, wherein receiving multiple streams includes receiving a timing stream that indicates a status of the processor for multiple clock cycles of the processor.

13. The method of claim 11, wherein receiving multiple streams includes receiving a data stream that indicates data accessed by said processor.

14. The method of claim 10, wherein receiving the first stream comprises receiving a program counter (PC) stream which includes program counter information associated with said processor.

15. The method of claim 10, wherein receiving the first stream comprises receiving a sync point which contains the status bit, said sync point further comprising another bit which indicates that the sync point is a periodic sync point.
